(19) United States
(12) Patent Application Publication
(10) Pub. No.: US 2009/0114345 A1
(43) Pub. Date: May 7, 2009

(54) Method for manufacturing a substrate for mounting a semiconductor element

(75) Inventors: Hiroki Nakayama, Kagoshima (JP); Juntarou Mikami, Kagoshima (JP)

Correspondence Address: DYKEMA GOSSETT PLLC, FRANKLIN SQUARE, THIRD FLOOR WEST, 1300 I STREET, NW, WASHINGTON, DC, 20005, US

(73) Assignee: SUMITOMO METAL MINING CO., LTD.

(21) Appl. No.: 12/289,473

(22) Filed: Oct. 28, 2008

(30) Foreign Application Priority Data
Nov. 7, 2007 (JP) 2007-290077
Aug. 26, 2008 (JP) 2008-217344

(51) Int. Cl. B29C 63/00

(52) U.S. Cl. 156/344

(57) ABSTRACT

A method for manufacturing a substrate for mounting a semiconductor element includes: a step for forming a predetermined resist pattern by affixing resists on both faces of a base material including a metallic thin plate and using the resist of one of the faces as a masking for plating; a step for performing an etching of a predetermined position on a base material exposed from the resist pattern; a step for forming a plating layer having at least three layers including a lower, a middle, and an upper layer on the etched base material; a step for separating the resists affixed to both faces of a base material; and a step for performing an etching of the middle plating layer to make the middle plating layer narrower than the upper and lower plating layers.

### BACKGROUND OF THE INVENTION

1. Field of the Invention

The present invention relates to a method for manufacturing a substrate for mounting a semiconductor element, and in particular, a method for manufacturing a substrate for mounting a semiconductor element, including a multilayered plating layer formed on a substrate including a metallic thin plate, to provide excellent adhesion between the substrate and the plating layer during assembly steps and exceedingly easy separation between the base material and the plating layer after completion of the assembly.

2. Description of the Related Art

Size and thickness reductions of semiconductor devices are progressing year by year, and the number of semiconductor devices having connectors (leads) on the bottom face of a sealing resin for external connection is increasing. It was common to use a leadframe made of copper alloy or iron-nickel alloy formed into a predetermined pattern by performing etching or pressing as a pad and leads of such a semiconductor device. However, such a leadframe generally uses a metallic thin plate having a plate thickness of 0.125 mm to 0.20 mm and is one impediment to thickness reductions of semiconductor devices.

Recently therefore, to replace such leadframes, substrates for mounting semiconductor elements have been developed wherein a plating layer, formed on a surface of a base material including a metallic thin plate and having a thickness of no more than 0.1 mm, is used as the pad and the leads. Products that assemble semiconductor devices using such substrates for mounting a semiconductor element are being used commercially. As an example of a substrate for mounting a semiconductor element having a pad and leads formed by a plating layer on a base material, a method has been proposed (for example, Japanese Published Unexamined Patent Application No. 59-208756) wherein a base material including an etchable metal material is selected in advance; a substrate for mounting a semiconductor element is obtained by forming a pad and leads including a gold plating layer, a nickel plating layer, and a gold plating layer on the base material; a semiconductor element is mounted on the pad; the semiconductor element is linked to the leads by wire bonding; and after assembly steps such as a resin sealing, only the base material is removed by etching.

Furthermore, many proposals have been made for a substrate for mounting a semiconductor element having a connector formed by a plating layer on the bottom face of a sealing resin wherein a metallic thin plate of a base material is removed from the resin sealing body by peeling. However, in the case of such a substrate for mounting a semiconductor element, separation is poor between the metallic thin plate of the base material and the created plating layer. For example, in the case where copper alloy is used as the base material, peeling cannot be performed easily by mechanical methods, and therefore an etching processing is necessary as a method for removing the copper alloy, i.e., the metallic thin plate, after the resin sealing. Such limitations result in complex manufacturing steps and poor economic feasibility. Moreover, the formed pad and leads may unfortunately remain on the metallic thin plate that is peeled and removed. In an effort to improve the separation, a method is proposed (for example, Japanese Published Unexamined Patent Application No. 10-50885) for performing a plating processing after creating an unevenness on the surface of the metallic thin plate by performing a blasting in advance. However, the surface processing for creating an unevenness on the metallic thin plate causes new problems such as warp of the base material; and other problems remain associated with the increased complexity of the manufacturing steps added to perform the surface processing step and the separation processing step.

On the other hand, in the case where stainless steel is used as a metallic thin plate of a base material and the stainless steel thin plate is peeled after a resin sealing, generally, the adhesion is insufficient between the plating layer forming the leads and the stainless steel, and unfortunately the sealing resin penetrates between the stainless steel thin plate and the plating layer. Additionally, it is important that, after the resin sealing, the plating layer of the pad and the leads adheres closely to the sealing resin and prevents lifting or separation from the sealing resin. As a method for improving the adhesion between the sealing resin and the plating layer, a method is discussed (for example, Japanese Published Unexamined Patent Application No. 2003-174121) for overhanging a circumferential edge of an upper end of the plating layer in a protective form. However, this method involves forming the plating layer to overhang on or above the top of the resist. Therefore, it is not easy to control the overhang length of the protective form, and unfortunately the protective form may connect with an adjacent lead. As another method for improving the adhesion of the sealing resin and the created plating layer, a semiconductor device and a method for manufacturing the same are discussed (for example, Japanese Published Unexamined Patent Application No. 2004-253674) wherein a substrate including a lead having a cross section formed in an “I” shape is used. More specifically, in this method, a conductive member is formed in a predetermined pattern on both faces of a metal foil; the resulting configuration is affixed to a base material via a bonding agent layer; and then the metal foil is etched using the conductive member as an etching mask, thereby manufacturing a substrate for mounting a semiconductor element including an “I” shaped cross section. However, new manufacturing steps are added, and as a result, problems remain regarding costs due to the complexity caused by the manufacturing steps.

### SUMMARY OF THE INVENTION

In the case of the substrate for mounting a semiconductor element recited above obtained by thus using a metallic thin plate as a base material and by removing the metallic thin plate by peeling after a resin sealing, it is necessary that the plating layer does not separate from the metallic thin plate during the assembly steps, and additionally that the plating layer is adhered closely to the metallic thin plate to prevent the sealing resin from penetrating therebetween. Furthermore, it is important to make sure the plating layer forming the pad and the leads adheres closely to the sealing resin, does not remain on the peeled metallic thin plate after the metallic thin plate is peeled, and does not lift or separate from the sealing resin. In other words, contradicting functions are required, wherein the metallic thin plate and the plating layer are strongly and closely adhered through the completion of the assembly steps, and yet the metallic thin plate and the plating layer are separated easily when the metallic thin plate is peeled. The present invention provides a method for manufacturing a substrate for mounting a semiconductor element using a method for peeling a substrate and is directed to solve both of the problems recited above by providing a method for manufacturing a substrate for mounting a semiconductor element, wherein: a base material and a plating layer do not separate during assembly steps; the adhesion between the base material and the plating layer is strongly maintained to prevent a sealing resin from penetrating therebetween; the base material and the plating layer are exceedingly easy to separate after the assembly; the plating layer does not remain on the removed base material; and the plating layer remains adhered closely to the sealing resin and does not lift or separate therefrom.

A method for manufacturing a substrate for mounting a semiconductor element according to the present invention for solving the problems recited above is directed to provide a method for manufacturing a substrate for mounting a semiconductor element having characteristic configuration requirements of: a step for forming a predetermined resist pattern by affixing resists on both faces of a base material including a metallic thin plate and using the resist of one of the faces as a masking for plating; a step for performing an etching at a predetermined position on a base material exposed from the resist pattern; a step for forming a plating layer having at least three layers including a lower, a middle, and an upper layer on the etched base material; a step for separating the resists affixed to both faces of a base material; and a step for performing an etching of the middle plating layer to make the middle plating layer narrower than the upper and lower plating layers.

Furthermore, in the case of the method for manufacturing a substrate for mounting a semiconductor element recited above according to the present invention, a favorable aspect is provided wherein the metallic thin plate is stainless steel having a plate thickness of 0.05 to 0.5 mm.

Additionally, the method for manufacturing a substrate for mounting a semiconductor element recited above according to the present invention is characterized in that a depth of the etching performed at a predetermined position on a base material is within the range of 3 to 10 μm.

The method for manufacturing a substrate for mounting a semiconductor element recited above according to the present invention is also characterized in that the etching performed at a predetermined position on a base material is replaced by initially forming a gold plating layer using a strongly acidic bath.

The method for manufacturing a substrate for mounting a semiconductor element recited above according to the present invention is further characterized in that an etching is performed on a side face of the middle plating layer in a central direction to a range of 2 to 10 μm per side, and a surface area of the middle plating layer becomes narrower in comparison to a surface area of each of a lower plating layer and an upper plating layer.

Furthermore, the method for manufacturing a substrate for mounting a semiconductor element recited above according to the present invention is characterized in that the lower plating layer includes a gold and/or nickel plating, the middle plating layer includes a copper and/or nickel plating, and the upper plating layer includes a plating of nickel, gold, silver, palladium, or alloys thereof.

Additionally, the method for manufacturing a substrate for mounting a semiconductor element recited above according to the present invention is characterized in that the upper plating layer is formed with a thickness of at least 5 μm.

Still furthermore, the method is characterized in that the middle plating layer includes a plating layer that is not etched from the side face in a central direction, and thereby the middle plating layer narrower than the upper and lower plating layers has a protruding portion therein.

A semiconductor device was assembled using a substrate for mounting a semiconductor element manufactured by the manufacturing method of the present invention, wherein a plating layer created on a substrate included an upper plating layer having a thickness of at least 5 μm and a middle plating layer formed narrower than the upper and lower plating layers; and therefore the adhesion was excellent between the sealing resin and the plating layer, thereby preventing the plating layer from lifting or separating from the sealing resin after the base material was peeled. Furthermore, in particular, a plating layer initially formed on the base material was a gold plating layer made especially by a strongly acidic bath in place of the weakly acidic to neutral bath generally used, which thereby improved the adhesion to the substrate and prevented the sealing resin from penetrating between the base material and the plating layer. Additionally, etching was performed to a depth of 3 to 10 μm at a predetermined position on the base material, and a plating layer was formed thereon, which thereby provided even more protection against the sealing resin penetrating between the base material and the plating layer. Thus, the substrate for mounting a semiconductor element obtained by the method of the present invention provided excellent adhesion between the created plating layer and the sealing resin, prevented the plating layer forming the pad and the leads from remaining on the peeled base material after the base material was peeled, and provided exceedingly excellent effects as a substrate for mounting a semiconductor element despite being a manufacturing method of simple steps.

### BRIEF DESCRIPTION OF THE DRAWINGS

FIG. 1 illustrates a substrate for mounting a semiconductor element obtained by one example based on the present invention, of which (a) is an essential component cross-sectional view illustrating a state wherein a three-layered plating layer is formed on a substrate; (b) is an essential component cross-sectional view illustrating a state wherein a five-layered plating layer is formed; and (c) is an essential component cross-sectional view of a seven-layered plating layer illustrating a state of a plurality of plating layers wherein a middle plating layer has a protruding portion.

FIG. 2 illustrates a state wherein multiple sets of plating layers are formed on a substrate by a resist pattern of which (a) is an essential component plan view, and (b) is a partially enlarged plan view of (a).

FIG. 3 is a cross-sectional view illustrating, for each step, a method for forming a three-layered plating layer on a substrate for a method for manufacturing a substrate for mounting a semiconductor element based on the present invention, of which (a) is an essential component cross-sectional view illustrating a state wherein a pattern is formed by a resist; (b) is an essential component cross-sectional view illustrating a state wherein an etching is performed on the substrate; (c) is an essential component cross-sectional view illustrating a state wherein a three-layered plating layer is formed on the substrate; (d) is an essential component cross-sectional view illustrating a state wherein the resist pattern is separated; and (e) is an essential component cross-sectional view illustrating a state wherein etching is performed on a middle plating layer.

FIG. 4 illustrates a state of a substrate after a resin sealing for a method for manufacturing a substrate for mounting a semiconductor element based on the present invention, of which (a) is an essential component enlarged cross-sectional view illustrating a substrate obtained by a first example and (b) is an essential component enlarged cross-sectional view illustrating a substrate obtained similarly by a second and a third example.

FIG. 5 is a schematic cross-sectional view illustrating a plating layer of the present invention for a method for manufacturing a substrate for mounting a semiconductor element based on the present invention, of which (a) is a schematic cross-sectional view of a five layered structure formed by three types of plating layers and (b) is a cross-sectional view of a seven layered structure formed by three types of plating layers.

### DESCRIPTION OF THE REFERENCE NUMERALS

11 Base material
12 Dry film resist
13 Etching portion
21 Lower plating layer
22 Middle plating layer
23 Upper plating layer
31, 35 Gold plating layer
32, 33b, 34 Nickel plating layer
33a Copper plating layer
40 Plating area
41 Pad
42 Lead
50 Substrate for mounting a semiconductor element after a resin sealing
51 Semiconductor element
52 Lead
53 Wire bonding
54 Pad
55 Sealing resin

### DETAILED DESCRIPTION OF THE PREFERRED EMBODIMENTS

Hereinafter, the present invention will be described in greater detail based on the attached drawings and examples, but the present invention is in no way constrained thereby, and design modifications can be made freely within the scope of the spirit of the present invention.

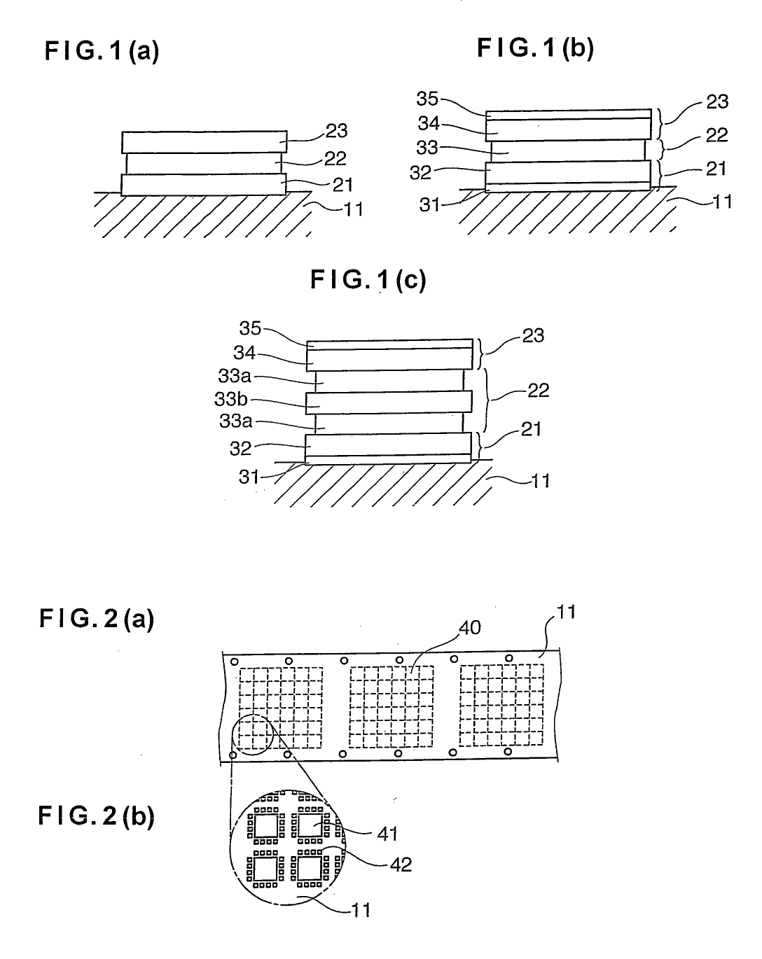

FIG. 1 illustrates a substrate for mounting a semiconductor element obtained by one example based on the present invention, of which (a) is an essential component cross-sectional view illustrating a state wherein a three-layered plating layer is formed on a substrate; (b) is an essential component cross-sectional view illustrating a state wherein a five-layered plating layer is formed; and (c) is an essential component cross-sectional view of a seven-layered plating layer illustrating a state of a plurality of plating layers wherein a middle plating layer has a protruding portion.

FIG. 2 illustrates a state wherein multiple sets of plating layers are formed on a substrate of which (a) is an essential component plan view, and (b) is a partially enlarged plan view of (a).

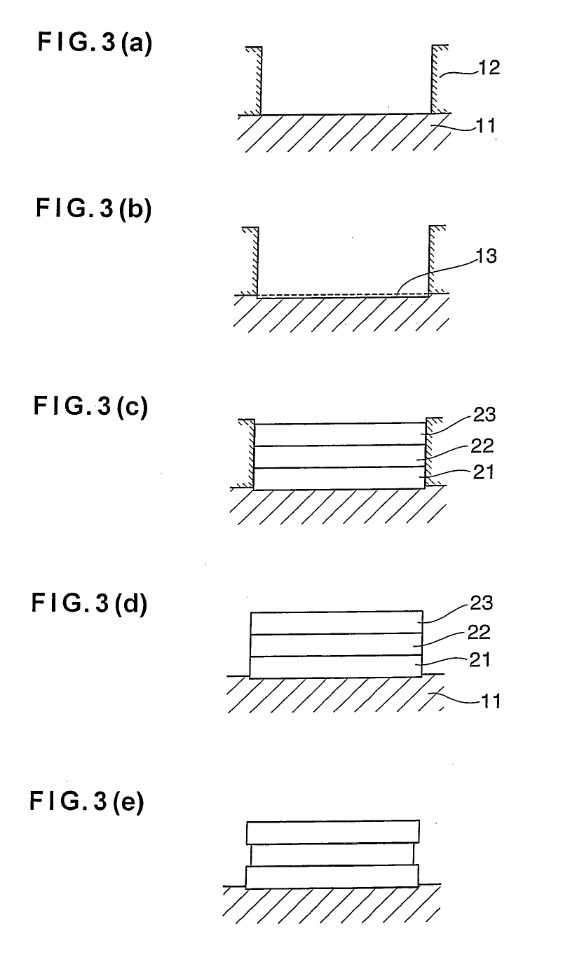

FIG. 3 is a cross-sectional view illustrating, for each step, a method for forming a three-layered plating layer on a substrate for a method for manufacturing a substrate for mounting a semiconductor element based on the present invention, of which (a) is an essential component cross-sectional view illustrating a state wherein a pattern is formed by a resist; (b) is an essential component cross-sectional view illustrating a state wherein etching is performed on the substrate; (c) is an essential component cross-sectional view illustrating a state wherein a three-layered plating layer is formed on the substrate; (d) is an essential component cross-sectional view illustrating a state wherein the resist pattern is separated; and (e) is an essential component cross-sectional view illustrating a state wherein an etching is performed on a middle plating layer.

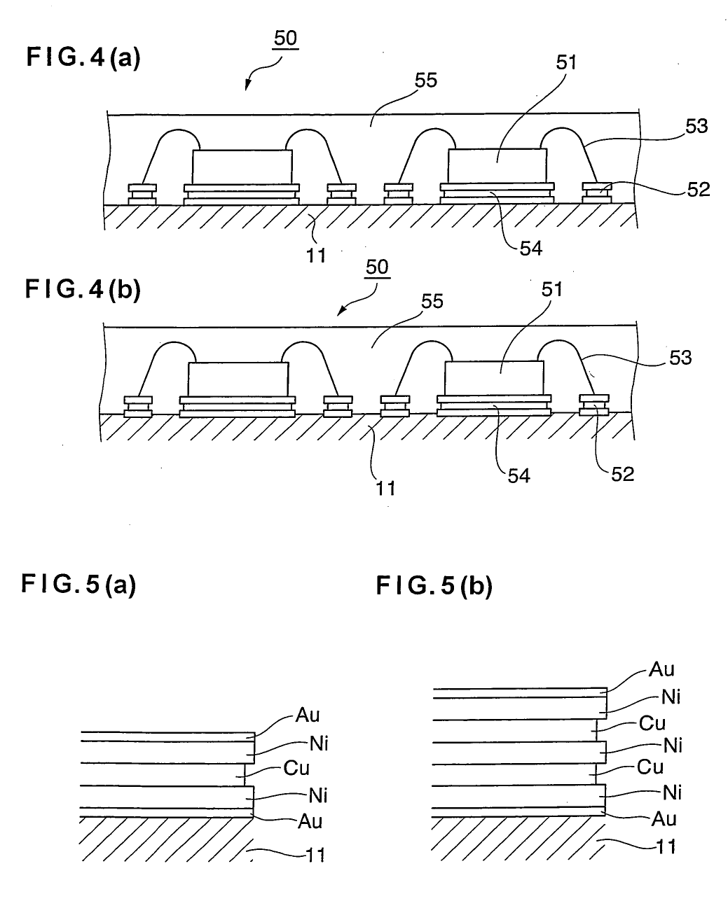

FIG. 4 illustrates a state of a substrate after a resin sealing for a method for manufacturing a substrate for mounting a semiconductor element based on the present invention, of which (a) is an essential component enlarged cross-sectional view illustrating a substrate obtained by a first example and (b) is an essential component enlarged cross-sectional view illustrating a substrate obtained similarly by a second example.

FIG. 5 is a schematic cross-sectional view illustrating a plating layer of the present invention for a method for manufacturing a substrate for mounting a semiconductor element based on the present invention, of which (a) is a schematic cross-sectional view of a five layered structure formed by three types of plating layers and (b) is a schematic cross-sectional view of a seven layered structure formed by three types of plating layers.

Now to describe a favorable embodiment of a method for manufacturing a substrate for mounting a semiconductor element according to the present invention in order of the steps, a plate made of stainless steel (SUS 430) having a plate thickness of 0.05 to 0.5 mm and favorably 0.1 to 0.3 mm is used as a base material including a metallic thin plate; resists including a photosensitive dry film are affixed to both faces of the base material; then, a processing to form a plating mask is performed on the resist of one face; and a predetermined pattern is made on the base material. Then, etching is performed to a depth of 3 to 10 μm in a plating area of the base material using an iron solution. In the case where the depth of the etching is less than 3 μm, the sealing resin may penetrate between the base material and the plating layer; and in the case where the depth of the etching is more than 10 μm, the plating layer forming a pad and leads remains on the base material after the base material is peeled, and therefore it is desirable to perform the etching to a depth of 3 to 10 μm.

Plating layers are created in layers on the etched base material recited above in the order of an initial gold plating of a general weakly acidic to neutral bath, followed by nickel plating formed thereupon, and then copper plating, nickel plating, and gold plating thereupon. Thus, a five-layered plating layer is formed having a lower plating layer including gold plating and nickel plating, a middle plating layer including copper plating, and an upper plating layer including nickel plating and gold plating. Alternatively, a plating layer having seven or more layers may be created wherein the middle plating layer includes successive layers of copper plating and nickel plating.

Then, the resists affixed in advance to both faces of the base material are separated; and etching is performed to a depth, per side, of 2 to 10 μm on only a portion of the copper plating layer, i.e., the middle plating layer, and thereby the plating layers having schematic cross-sections as illustrated in FIG. 5 are formed. In the case where the etching of the side face is to a depth of less than 2 μm, an adhesion with the resin is insufficient; and conversely in the case where the depth is more than 10 μm, there is a risk that the upper plating layer may partially sag and lose its shape; and therefore it is desirable for etching to be performed within the range, per side, of 2 to 10 μm. As recited above, etching is performed on the middle plating layer, and therefore it is necessary for the upper plating layer to have a thickness of at least 5 μm.

Furthermore, in the case of the substrate for mounting a semiconductor element according to the present invention, the face of the lower plating layer recited above facing the base material is the portion that connects the semiconductor device to a motherboard and the like and therefore must be a plating that can adhere to solder. On the other hand, the uppermost layer of the upper plating layer is the portion that undergoes wire bonding, and therefore it is a necessary condition thereof to be a plating that can be wire bonded. In order to satisfy such conditions recited above, the plating layer on the substrate according to the present invention may be formed of, in order from the base material, a lower plating layer of gold plating or palladium plating; a middle plating layer of copper plating or nickel plating; and an upper plating layer of palladium plating or gold plating; and each of the lower, middle, and upper layers may be formed of an independent or a plurality of plating layers.

### FIRST EXAMPLE

Stainless steel (SUS 430) having a plate thickness of 0.2 mm was used as a metallic thin plate of a base material 11, and after performing a degrease/acid rinse processing, photosensitive dry film resists 12 having thicknesses of 0.025 mm were affixed to both faces of the base material 11 by a laminating roll; then, the dry film resist 12 of one face of the base material 11 was covered by a glass mask as a plating mask, on which an ultra-violet light was irradiated to perform an exposure; a development processing was performed; and a predetermined pattern was made by the dry film resist 12.

At this time, a feature having a 3 mm×3 mm pad 41 and sixteen 0.5 mm×0.5 mm leads 42 arranged around the pad 41 was prepared, and such a feature was arranged in a set of six by six features in a central vicinity of a base material having a width of 40 mm as illustrated in FIG. 2; and thus the pattern made multiple sets in an arrangement as a plating area 40 for forming the plating layers.

Then, a pre-plating processing was performed on the plating area 40 on the base material, after which essentially a three-layered plating layer was formed on the base material by: forming about 0.1 μm of gold plating by a strongly acidic bath of pH 0.1 to 1.0; forming about 10 μm of nickel plating thereupon; forming about 10 μm of copper plating thereupon; forming about 5 μm of nickel plating thereupon; and forming about 0.1 μm of gold plating thereupon by a weakly acidic to neutral bath. Thus, the following plating layers were formed in order from the base material: a lower plating layer 21 including a thin gold plating layer and a 10 μm nickel plating layer; a middle plating layer 22 including a 10 μm copper plating layer; and an upper plating layer 23 including a 5 μm nickel plating layer and a 0.1 μm gold plating layer (the gold plating layers are thin and therefore are not counted).

Then, the dry film resists 12 affixed in advance to both faces of the base material 11 were separated and a water rinse and drying were performed, after which an iron solution was used to perform an etching of the copper plating layer, i.e., the middle plating layer, to a depth, per side, of about 7 μm from the side face toward the central portion thereof. As recited above, this series of fabrication steps formed plating layers on the base material having the lower plating layer 21 including a gold plating layer 31 and a nickel plating layer 32, the middle plating layer 22 including a copper plating layer 33, and the upper plating layer 23 including a nickel plating layer 34 and a gold plating layer 35; and a substrate for mounting a semiconductor element was obtained having a copper plating layer 33, i.e., the middle plating layer 22, that is about 7 μm narrower, per side, than the upper and lower plating layers as illustrated in the essential component cross section of FIG. 1(b).

Using the substrate for mounting a semiconductor element obtained according to this example, a semiconductor element 51 was mounted on a pad 54 using paste for die bonding, and a wire bonding 53 was performed between the electrodes of the semiconductor element 51 and the leads 52. Then, a resin sealing was performed using a sealing resin 55 for sealing the three components together as illustrated in FIG. 4(a) (the reader is directed to the substrate for mounting a semiconductor element 50 after the resin sealing); after a resin hardening, the stainless steel, i.e., the base material 11, was peeled from the resin sealed portion; and a careful observation of the peeled stainless steel showed that no portions of the plating layer remained, and moreover, it was confirmed that the gold plating of the resin sealed portion that was in contact with the stainless steel was closely retained with no traces of penetration of the sealing resin 55 and no lifting or separation of the plating layer from the sealing resin 55.

### SECOND EXAMPLE

First, using a base material 11 similar to the base material of the first example having a predetermined pattern formed on a surface by a dry film resist, an etching was performed to a depth of about 7 μm on a plating area 40 of the base material 11 by an iron solution; and except for the formation of an etching portion 13 in the applicable portions, a substrate for mounting a semiconductor element was obtained by an essentially similar method as that of the first example. Using the obtained substrate for mounting a semiconductor element, a semiconductor element 51 was mounted on the pad 54 using a paste for die bonding, and a wire bonding was performed between the electrodes of the semiconductor element 51 and the leads 52. Then, a resin sealing was performed for sealing the three components together as illustrated in FIG. 4(b) (the reader is directed to the substrate for mounting a semiconductor element 50 after the resin sealing); and after a resin hardening, the stainless steel, i.e., the base material 11, was peeled from the resin sealed portion. A careful observation of the surface of the peeled stainless steel showed that no portions of the plating layer remained, and moreover, it was confirmed that the gold plating of the resin sealed portion that was in contact with the stainless steel was closely retained with no traces of penetration of the sealing resin and no lifting or separation of the plating layer from the resin.

### THIRD EXAMPLE

Using copper alloy in place of the stainless steel of the first example, a base material 11 having a predetermined patterned made similarly by a dry film resist was used. A substrate for mounting a semiconductor element according to this example was obtained by first performing etching to a depth of about 7 μm on the a plating area 40 of the base material 11 by an iron solution; performing a pre-plating processing; then forming a total of about 15 μm of plating layers on the base material by forming about 3 μm of gold plating by a neutral bath, forming about 6 μm of nickel plating thereupon, and forming about 6 μm of silver plating thereupon; then separating the dry film resists remaining on the base material surface; and performing etching to a depth of about 5 μm on the nickel plating layer by selective etching. Using the obtained substrate for mounting a semiconductor element, a resin sealing was performed similarly to that of the first example. After a resin hardening, a dissolution processing was performed on the copper alloy, i.e., the base material 11, by an etchant, and the resin including the formed plating layer was left. It was confirmed that the gold plating portion of the plating layer on the resin side that was in contact with the copper alloy was retained in a close state with no traces of penetration of the sealing resin and no observed appearance of lifting or separation of the plating layer from the resin.

### FOURTH EXAMPLE

First, using a base material 11 similar to that of the first example having a predetermined pattern made by a dry film resist, a pre-plating processing was performed on the plating area 40 on the base material 11; after which a substrate for mounting a semiconductor element was obtained by forming about 0.1 μm of gold plating by a strongly acidic bath of pH 0.1 to 1.0, forming about 5 μm of nickel plating thereupon, forming about 5 μm of copper plating thereupon, forming about 5 μm of nickel plating thereupon, forming about 5 μm of copper plating thereupon, forming about 5 μm of nickel plating thereupon, and forming about 0.1 μm of gold plating thereupon by a weakly acidic to neutral bath. Thus, the following plating layers were formed in order from the base material: the lower plating layer 21 including the gold plating layer 31 and the nickel plating layer 32; the middle plating layer 22 including three layers of a copper plating layer 33a, a nickel plating layer 33b, and a copper plating layer 33a; and the upper plating layer 23 thereupon including the nickel plating layer 34 and the gold plating layer 35.

Then, the dry film resists were separated, an etching was performed to a depth of about 6 μm on the copper plating layer by an alkaline etchant, and the essential component cross section of FIG. 1(c) was formed. Using the obtained substrate for mounting a semiconductor element, a resin sealing was performed similarly to that of the first example. After a resin hardening, the stainless steel, i.e., the base material 11, was peeled from the resin sealed portion. Observation of the peeled stainless steel showed that no portion of the plating layer remained, and moreover, regarding the gold plating layer of the resin sealed portion that was in contact with the stainless steel, retention in a close state with no traces of penetration of the sealing resin and no observed appearance of lifting or separation of the plating layer from the resin was confirmed. Furthermore, after forming a solder joint by reflow, the adhesion strength between the sealing resin and the metal leads was measured by a destructive test, and higher strengths were obtained than for the first, second, and third examples.

On the other hand, further increasing the number of layers of the middle plating layer results in complex steps; and each plating layer must be thin to prevent a decline in productivity, thereby hindering the sealing resin from penetrating into the portions that were etched and reducing the retaining effect; and therefore, it may be considered that it is favorable to limit the number of layers to those of this example.

Thus, to increase the overall thickness of the formed plating layers, it is possible to increase the thickness of the middle plating layer or the thickness of the upper and lower plating layers, but an inclusion of a plating layer that is not etched inside the middle plating layer enables an improvement of the retaining effect of the sealing resin by using the protruding portion shapes of the upper and lower plating layer and the middle plating layer.

In addition to the examples recited above, according to the method for manufacturing a substrate for mounting a semiconductor element of the present invention, it is possible to appropriately combine as the three or more plating layers formed on the base material, for example, in order from the base material, gold plating, copper plating, and gold plating (or gold alloy plating); gold plating, palladium plating, nickel plating, palladium plating, and gold plating (or gold alloy plating); gold plating, palladium plating, nickel plating, gold plating, and silver plating (or silver alloy plating); or gold plating, palladium plating, nickel plating, and palladium plating (or palladium alloy plating), etc.

### INDUSTRIAL APPLICABILITY

A substrate for mounting a semiconductor element obtained by the method of the present invention, despite the manufacturing method having simple steps, provides excellent adhesion between a created plating layer and a sealing resin, prevents the plating layer forming a pad and leads from remaining on a peeled base material after the base material is peeled, and provides exceedingly excellent effects as a substrate for mounting a semiconductor element; and therefore widespread use is expected in applicable production fields.

What is claimed is:

1. A method for manufacturing a substrate for mounting a semiconductor element comprising:
a step for forming a predetermined resist pattern by affixing resists on both faces of a base material including a metallic thin plate and using the resist of one of the faces as a masking for plating;
a step for performing an etching at a predetermined position on a base material exposed from the resist pattern;
a step for forming a plating layer having at least three layers including a lower, a middle, and an upper layer on the etched base material;
a step for separating the resists affixed to both faces of a base material; and
a step for performing an etching of the middle plating layer to make the middle plating layer narrower than the upper and lower plating layers.

2. The method for manufacturing a substrate for mounting a semiconductor element according to claim 1, wherein the metallic thin plate is stainless steel having a plate thickness of 0.05 to 0.5 mm.

3. The method for manufacturing a substrate for mounting a semiconductor element according to claim 1, wherein a depth of the etching performed at a predetermined position on a base material is in the range of 3 to 10 μm.

4. The method for manufacturing a substrate for mounting a semiconductor element according to claim 2, wherein a depth of the etching performed at a predetermined position on a base material is in the range of 3 to 10 μm.

5. The method for manufacturing a substrate for mounting a semiconductor element according to claim 1, wherein the etching performed at a predetermined position on a base material is replaced by a formation of a gold plating layer using a strongly acidic bath.

6. The method for manufacturing a substrate for mounting a semiconductor element according to claim 2, wherein the etching performed at a predetermined position on a base material is replaced by a formation of a gold plating layer using a strongly acidic bath.

7. The method for manufacturing a substrate for mounting a semiconductor element according to claim 1, wherein
an etching is performed on a side face of the middle plating layer in a central direction to a range of 2 to 10 μm per side and
a surface area of the middle plating layer becomes narrower in comparison to a surface area of each of a lower plating layer and an upper plating layer.

8. The method for manufacturing a substrate for mounting a semiconductor element according to claim 1 wherein
the lower plating layer comprises a gold and/or nickel plating,
the middle plating layer comprises a copper and/or nickel plating, and
the upper plating layer comprises a plating of nickel, gold, silver, palladium, or alloys thereof.

9. The method for manufacturing a substrate for mounting a semiconductor element according to claims 1, wherein the upper plating layer is formed with a thickness of at least 5 μm.

10. The method for manufacturing a substrate for mounting a semiconductor element according to claim 1 wherein
the middle plating layer includes a plating layer that is not etched from the side face in a central direction and thereby
the middle plating layer narrower than the upper and lower plating layers has a protruding portion therein.
